(19) United States
(12) Patent Application Publication
(10) Pub. No.: US 2007/0104479 A1
(43) Pub. Date: May 10, 2007

(54) Correcting photographs obtained by a handheld device

(76) Inventor: Akihiro Machida, Sunnyvale, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/272,400

(22) Filed: Nov. 10, 2005

(51) Int. Cl. G03B 19/00

(52) U.S. Cl. 396/429

(57) ABSTRACT

A method that enables correction of photographs obtained by a handheld device without equipping the handheld device with bulky and expensive motion compensation mechanisms or expensive processing resources for supporting correction algorithms. A method for correcting a photograph according to the present teachings includes transferring the photograph from the handheld device to a remote system and then obtaining a corrected photograph from the remote system. The fact that a remote system corrects the photograph obviates the need for expensive mechanisms/resources in the handheld device.

### BACKGROUND

A variety of handheld devices that may not be traditionally regarded as cameras may be provided with the capability of taking photographs. For example, cell phones, PDAs, handheld digital music players, etc. may include digital cameras.

Photographs taken with a handheld device may exhibit blurring. For example, a user may inadvertently shake a handheld device while taking a photograph. The shaking motion of A handheld device may cause a number of adjacent pixels on its digital image sensor to sample light from the same area of an image scene, thereby yielding a blurred photograph.

Prior methods for avoiding blurred photographs include providing a camera with motion compensation mechanisms for adjusting the positions of its optics or its image sensor in response to movement of the camera. Unfortunately, such mechanisms may be too bulky and expensive for handheld devices.

Blurred pictures may be corrected using computer-based blur correction. Unfortunately, computer-based blur correction may require relatively powerful processing resources, e.g. a fast processor, math processing capability, large capacity memory, etc. that may be prohibitively expensive for a handheld device.

### SUMMARY OF THE INVENTION

A method is disclosed that enables correction of photographs obtained by a handheld device without equipping the handheld device with bulky and expensive motion compensation mechanisms or expensive processing resources for supporting correction algorithms. A method for correcting a photograph according to the present teachings includes transferring the photograph from the handheld device to a remote system and then obtaining a corrected photograph from the remote system. The fact that a remote system corrects the photograph obviates the need for expensive mechanisms/resources in the handheld device.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates a method for correcting a photograph obtained by a handheld device according to the present teachings;

FIG. 2 shows one embodiment of a handheld device according to the present teachings;

FIG. 3 illustrates the handling of a multimedia message in a remote system according to the present teachings.

### DETAILED DESCRIPTION

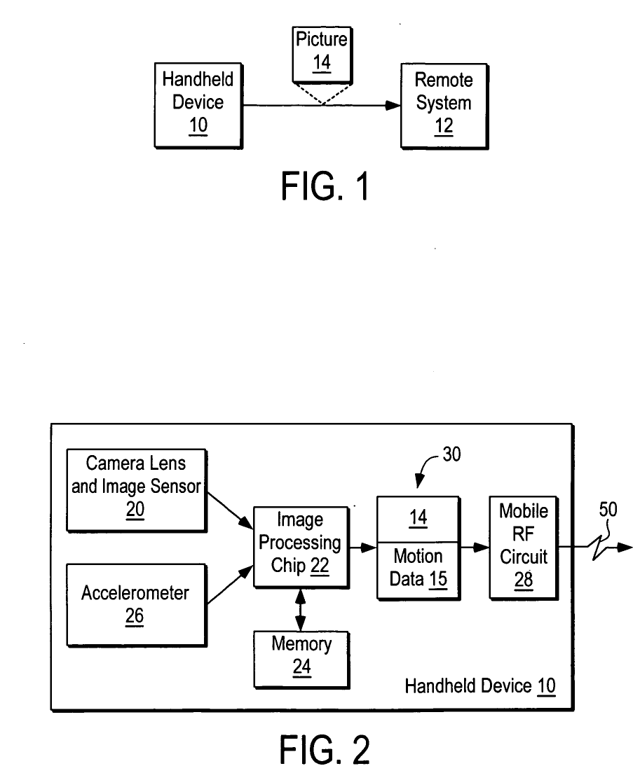

FIG. 1 illustrates a method for correcting a photograph 14 obtained by a handheld device 10 according to the present teachings. The present method includes a remote system 12 and the handheld device 10 transfers the photograph 14 to the remote system 12. The remote system 12 corrects the photograph 14 so that a corrected version of the photograph 14 may be obtained from the remote system 12.

The remote system 12 may apply any correction to the photograph 14. Example corrections that may be applied to the photograph 14 include blur correction, color correction, correction for problems of contrast, color casts, color saturation, dynamic range, scratches, blemishes, etc. The correction performed by the remote system 12 may be performed automatically in software or may include human intervention in combination with software tools.

In one embodiment, the remote system 12 obtains a set of meta data from the handheld device 10 and corrects the photograph 14 in response to the meta data. For example, the meta data from the handheld device 10 may indicate a movement of the handheld device 10 while it acquired the photograph 14 and the remote system 12 may use the meta data to apply blur correction to the photograph 14.

A user of the handheld device 10 may obtain a corrected version of the picture 14 from the remote system 12. For example, the remote system 12 may transfer a corrected version of the photograph 14 back to the handheld device 10. Another handheld device may obtain a corrected version of the picture 14 from the remote system 12. For example, the remote system 12 may forward a corrected version of the photograph 14 to another handheld device. Others may obtain a corrected version of the picture 14 from a picture server. For example the remote system 12 may forward a corrected version of the photograph 14 to a picture server. The remote system 12 may be an implementation of a picture server.

The handheld device 10 may be any device capable of taking photographs and communicating with the remote system 12. Examples of the handheld device 10 include camera phones as well as personal digital assistants (PDAs), handheld computers, laptops, digital music players, etc., with integrated digital cameras.

FIG. 2 shows one embodiment of the handheld device 10. The handheld device 10 in this embodiment includes a camera lens and image sensor 20, an image processing chip 22, a memory 24, an accelerometer 26, and a mobile RF circuit 28. The camera lens and image sensor 20, the image processing chip 22, the memory 24, and the accelerometer 26 may be contained on a camera module in the handheld device 10, e.g. a camera module in a camera phone.

The mobile RF circuit 28 enables communication via a network 50. The mobile RF circuit 28 may be shared for other functions in the in the handheld device 10, e.g. telephony, web access, downloading games, etc, depending on the implementation of the handheld device 10. For example, if the network 50 is a GSM network then the mobile RF circuit 28 is adapted to GSM communication and if the network 50 is a CDMA network then the mobile RF circuit 28 is adapted to CDMA communication.

The accelerometer 26 generates motion data that indicate movement of the handheld device 10. The accelerometer 26 may include a silicon pendulum structure in combination a piezo-electric structure that generates a sensor signal having a voltage that indicates a magnitude of a g-force on the handheld device 10. The accelerometer 26 may include circuitry for converting the sensor signal into a motion vector, a digital value, that indicates motion per unit of time.

The image processing chip 22 obtains a set of image data for the photograph 14 from the image sensor 20 when the handheld device 10 acquires a photograph, e.g. when a user positions the handheld device 10 and presses a shutter control on the handheld device 10. The image processing chip 22 obtains a set of motion data from the accelerometer 26 substantially contemporaneously with obtaining the image data of the photograph 14 from the image sensor 20. The closeness in time of sampling the photograph 14 and obtaining motion data yields motion data that may be used to correct blur in the photograph 14 caused by movement, e.g. shaking, of the handheld device 10 while the photograph 14 was acquired. The image processing chip 22 may obtain a series of motion vectors from the accelerometer 26 during acquisition of the photograph 14 and then derive vibration data from the motion vectors.

The image processing chip 22 generates a multimedia message 30 that includes the image data for the photograph 14 and that further includes a set of motion data 15 that corresponds in time to the acquisition of the photograph 14 as meta data. The mobile RF circuit 28 obtains the multimedia message 30 from the image processing chip 22 and sends it over the network 50.

The multimedia message 30 may include a JPEG encoding of the image data for the photograph 14 with the motion data 15 embedded into the JPEG data, e.g. as meta data, a watermark, etc. The multimedia message 30 may be a GPRS packet, a RX1TT packet, etc., depending on the cellular network to which the handheld device 10 is adapted.

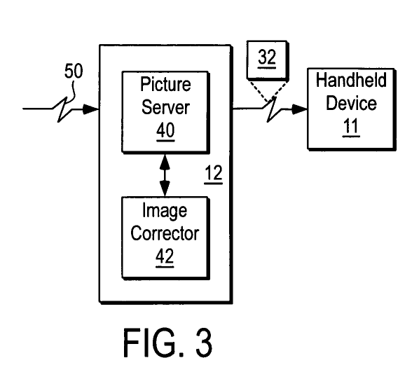

FIG. 3 illustrates the handling of the multimedia message 30 in one embodiment of the remote system 12. The remote system 12 in this embodiment includes a picture server 40 and an image corrector 42. The remote system 12 includes the appropriate network communication elements for communicating over the network 50 depending on the implementation of the network 50.

The picture server 40 may provide web based access to photographs obtained from the handheld device 10. For example, the picture server 40 may be part of a service of a camera phone service provider that enables photographs obtained by camera phones to be accessed by friends and family via the Internet using web protocols.

The picture server 40 obtains the multimedia message 30 from the handheld device 10 via the network 50. The picture server 40 extracts the photograph 14 and the motion data 15 from the multimedia message 30 and transfers the photograph 14 and the motion data 15 to the image corrector 42. The image corrector 42 corrects blur in the photograph 14 using the motion data 15. In an embodiment in which the handheld device 10 does not provide motion data, the image corrector 42 corrects blur in the photograph 14 in response to the image data of the photograph 14. The image corrector 42 may perform blur correction to the photograph 14 using known techniques.

The picture server 40 in this embodiment obtains a corrected photograph from the image corrector 42 and transfers the corrected photograph to a handheld device 11 in a multimedia message 32. For example, the handheld devices 10 and 11 may be camera phones that exchange photographs via a service of a cellular service provider that implements the present methods via the remote system 12. The picture server 40 may transfer the multimedia message 32 back to the handheld device 10 to provide the corrected photograph to a user of the handheld device 10. The picture server 40 may store the corrected photograph in a picture file associated with a user of the handheld device 10 and enable web access to the corrected photograph using Internet protocols. For example, the user of the handheld device 10 and friends and family, etc. of the user of the handheld device 10 may access the corrected photograph on the picture server 40 using a web browser.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for correcting a photograph obtained by a handheld device, comprising:
transferring the photograph from the handheld device to a remote system;
obtaining a corrected photograph from the remote system.

2. The method of claim 1, wherein obtaining a corrected photograph includes obtaining a corrected photograph with blur correction.

3. The method of claim 1, wherein transferring the photograph includes transferring a set of motion data pertaining to the photograph to the remote system.

4. The method of claim 3, wherein transferring the photograph includes transferring the photograph and the motion data in a multimedia message.

5. The method of claim 3, further comprising generating the motion data in the handheld device.

6. The method of claim 3, wherein obtaining a corrected photograph includes obtaining a corrected photograph with blur correction from the motion data.

7. The method of claim 1, wherein obtaining a corrected photograph includes transferring the corrected photograph to the handheld device.

8. The method of claim 1, wherein obtaining a corrected photograph includes transferring the corrected photograph to another handheld device.

9. The method of claim 1, wherein obtaining a corrected photograph includes obtaining the corrected photograph using a web access.

10. A system for correcting a photograph, comprising:
handheld device that acquires a photograph;
remote system that obtains the photograph from the handheld device and that in response provides access to a corrected version of the photograph.

11. The system of claim 10, wherein the corrected version of the photograph includes blur correction.

12. The system of claim 10, wherein the handheld device includes an accelerometer for generating a set of motion data associated with the photograph.

13. The system of claim 12, wherein the remote system obtains the motion data from the handheld device.

14. The system of claim 13, wherein the corrected version of the photograph includes blur correction using the motion data.

15. The system of claim 13, wherein the remote system obtains the photograph and the motion data via a network.

16. The system of claim 15, wherein the remote system obtains the photograph and the motion data in a multimedia message via the network.

17. The system of claim 10, wherein the remote system transfers the corrected version of the photograph to the handheld device.

18. The system of claim 10, wherein the remote system transfers the corrected version of the photograph to another handheld device.

19. The system of claim 10, wherein the remote system enables web access to the corrected version of the photograph.
